(19) United States
(12) Patent Application Publication
(10) Pub. No.: US 2020/0027296 A1
(43) Pub. Date: Jan. 23, 2020

(54) VOTER-VERIFIED DIGITAL VOTING AUDIT TRAIL

(71) Applicant: Dominion Voting Systems, Inc., Denver, CO (US)

(72) Inventor: James Hoover, Outremont, CA (US)

(21) Appl. No.: 16/518,632

(22) Filed: Jul. 22, 2019

Related U.S. Application Data
(60) Provisional application No. 62/702,235, filed on Jul. 23, 2018.

(51) Int. Cl. G07C 13/00; G06F 3/0482; G06F 3/16; G06K 9/00

(52) U.S. Cl. CPC G07C 13/00; G06K 9/00442; G06F 3/167; G06F 3/0482

(57) ABSTRACT

Methods, systems, and devices are described that provide for a voter-verified digital voting audit trail. One or more votes cast by a voter may be identified at a voting system, and a digital image that lists the identified votes may be generated. The digital image may be stored in a memory and displayed to the voter. The voter may be prompted to provide a voter verification of the displayed votes. Upon receiving the verification from the voter, the voter verification of the digital image containing the votes may be stored to provide a voter-verified digital audit trail. A cast vote record is generated based on the verified votes, and linked to the stored digital image and voter verification. The cast vote record may be provided to a tabulation system that may tabulate votes from multiple voters.

### CROSS-REFERENCES

The present application for patent claims priority to U.S. Patent Application No. 62/702,235 by Hoover, entitled “VOTER-VERIFIED DIGITAL VOTING AUDIT TRAIL,” filed Jul. 23, 2018, assigned to the assignee hereof and incorporated by reference herein.

### BACKGROUND

The present invention relates to voting systems in general and, in particular, to methods and systems for providing voter-verified digital voting audit trails.

Electronic tabulation of ballots has been used in elections for some time and provides efficient vote tabulation. Electronic tabulation systems may tabulate votes generated electronically at a voting machine, votes that are optically scanned from voter-marked paper ballots, or combinations thereof. Electronic votes may be cast by a voter using a direct-recording electronic (DRE) voting machine, in which the voter may electronically enter votes (e.g., via a touch-screen, audio interface, or other user interface). Optical scan systems may scan voter-marked paper ballots, which may have target areas that are evaluated by a computer that receives an image of the scanned ballot to determine if a vote is cast for a particular election (e.g., based on marks in a bubble or square next to a candidate's name on a ballot).

In some electronic systems, and in some optical scan systems, a paper audit trail may be provided and may be used as an independent verification system to allow a voter to verify that their vote was cast correctly in a DRE system or correctly read by an optical scan system, and to allow for an audit of stored electronic results. In some cases, a voter may be prompted to verify that the paper audit trail accurately reflects the votes cast by the voter. In some cases, the paper audit trail may include names of candidates for whom the voter cast a vote, cast votes for one or more referenda on a ballot, other items on which a voter may vote, or combinations thereof.

### SUMMARY

Methods, systems, and devices are described for a voter-verified digital audit trail. In some cases, a voting system may identify one or more voting selections made by a voter and generate a digital image that lists the one or more selections. The digital image may be stored, and displayed to the voter at the voting system, and the voter may verify that the listed selections accurately represent the votes cast by the voter. The voter-verified votes may then be provided as a cast vote record to a tabulation system. The voter verification may be used to cast the voter's ballot, and the verified digital image may be stored as a digital audit trail. Such a voter-verified digital audit trail may provide enhanced auditing capability and accessibility relative to a paper audit trail. For example, a voting authority, such as a secretary of state that manages elections, may provide network access to voter-verified digital audit trails such that individuals performing an audit are not required to be at a same physical location as a paper audit trail. Furthermore, secure copies of the voter-verified digital audit trails of an election may be created, thus allowing multiple parties to access the information without risk of alterations or spoliation of the information.

In some aspects of the disclosure, methods for verifying a vote cast by a voter are provided that include identifying votes made by the voter at a voter interface of a voting system, generating a digital image that lists the identified votes, storing the digital image of the identified votes in a memory, displaying the digital image to the voter, prompting the voter to provide a voter verification of the displayed votes, receiving the voter verification, and storing the voter verification of the digital image containing the votes to provide a voter-verified digital audit trail. In some cases, a cast vote record is generated based on the verified votes, and linked to the stored digital image and voter verification. The cast vote record may be provided to a tabulation system that may tabulate votes from multiple voters. In some cases, a digital signature (e.g., a cryptographic hash) may be generated based on information in the digital image and the voter verification that may be used to prevent alteration of the digital image, voter verification, or both. The digital image may be any type of digital image such as, for example, a bitmap image, a jpeg image, a tiff image, a gif image, a png image, or a pdf image. In some cases, the votes may be identified via a DRE interface at the voting system, an optical scan interface, or other vote determination interface.

In some aspects of the disclosure, the votes may be provided to the system through an audio ballot interface, in which audio ballot selections may be played for a voter and inputs may be received from the voter to indicate a vote. A separate audio file (e.g., a mpeg file, wma file, way file, etc.) may be generated that includes an auditory representation of the votes received from the voter. This separate audio file may be stored as a digital audit trail, and may be played back to the voter, and the voter may verify that the votes identified in the audio file are correct. The voter-verified votes then may be provided to the tabulation system.

In some aspects of the disclosure, a voting system may be provided that includes a voter interface, vote identification component, digital image generator, and a memory. In some cases, the voter interface may be a DRE interface or an optical scan interface, and may be coupled with the vote identification component, which may identify votes made by the voter. The digital image generator may be coupled with the vote identification component, and may generate a digital image of a list of the identified votes, which may be presented to the voter for verification to provide a voter-verified digital audit trail. A memory may be coupled with the digital image generator and voter interface and may store the digital image and the voter verification of the digital image. In some cases, the voter interface may include an audio interface, and the digital image generator may generate an audio file containing a list of the identified votes which may be played back to the voter for verification.

### BRIEF DESCRIPTION OF THE DRAWINGS

FIG. 1 illustrates a voting system including components configured in accordance with aspects of the present disclosure.

FIG. 2 illustrates a block diagram of a voting system including components configured in accordance with aspects of the present disclosure.

FIGS. 3A and 3B illustrate images of an electronic ballot that a voter may complete in accordance with aspects of the present disclosure.

FIGS. 4A and 4B illustrate images of a paper ballot that is marked by a voter in accordance with aspects of the present disclosure.

FIG. 5 illustrates a digital image that may be generated, stored, and provided to a voter to verify that voting selections have been properly recorded or read in accordance with aspects of the present disclosure.

FIG. 6 illustrates a block diagram of a voting terminal in accordance with aspects of the present disclosure.

FIG. 7 illustrates a block diagram of a tabulation system in accordance with aspects of the present disclosure.

FIG. 8 illustrates a flow chart of a method for generating a voter-verified digital audit trail in accordance with aspects of the present disclosure.

FIG. 9 illustrates a flow chart of another method for generating a voter-verified digital audit trail in accordance with aspects of the present disclosure.

FIG. 10 illustrates a flow chart of another method for generating a voter-verified digital audit trail in accordance with aspects of the present disclosure.

FIG. 11 illustrates a flow chart of a method for generating a voter-verified digital audit trail in conjunction with ballot processing in accordance with aspects of the present disclosure.

### DETAILED DESCRIPTION

Methods, systems, and devices are described for generating a voter-verified digital audit trail for votes cast by voters in an election. Such a voter-verified digital audit trail may be used as an independent verification system to allow a voter to verify that their vote was cast correctly in a DRE system, correctly read by an optical scan system, or correctly captured in an audio or accessible voter interface. Furthermore, the voter-verified digital audit trail may allow for an audit of stored electronic results. In some cases, the voter-verified digital audit trail may include a list of votes made by the voter in human readable form, machine readable form, or combinations thereof.

Such voter-verified digital audit trails may provide benefits over many voting systems today, in which after a voter has completed selections, the electronic records of vote choices and overall activities may be stored in multiple computer memory locations. Tallied totals, and post-election audits may be performed from these electronic records, as well as from paper records. For example, in precinct count optical scan and DRE systems, once the choices are stored in computer memory, many systems allow the voter to confirm their choices after they have completed their ballot selections. The content of the vote review screen is dynamically and temporarily created at the instant of the review from the computer memory. While the objective of this review is to demonstrate that the voter confirms the data ultimately used to tally of results, such systems in fact provide only data that is dynamically constructed for presentation to the voter, and then overwritten. Review content is confirmed by the voter, such as on a computer display screen or audio playback, but the review screen content is not. At most, the audit trail only contains a confirmation that the voter confirmed the display, but not what was actually contained in the memory.

Techniques provided herein provide that a digital audit trail that lists the votes of a voter is generated after the voter completes their initial selections, and is permanently stored in the computer memory for the duration of the election event. The voter review of the digital image or audio file is performed using this static and permanent digital record, which allows the voter to directly confirm the digital audit trail of their choices as the final step in the casting of their ballot. The voter verification of the digital file may be stored along with the digital file, in some cases, and may be used as an audit tool to provide election officials with an ability to state that the voters have all confirmed that the digital audit trail records of their ballots are correct.

Such a digital audit trail may be used in any format of voting (e.g., DRE voting, optical scan voting, audio voting, etc.), and once the voter selections are identified, the voter is provided with a static document in voter review which becomes the voter-verified digital audit trail. In the case of a system that provides a voter-verifiable paper audit trail (VVPAT), which is a printed audit record containing vote choices and overall activities, the voter-verified digital audit trail may be an electronic image captured from the printed VVPAT and displayed on screen for voter verification. In cases where optical scan systems are used, the electronic audit trail may be a tabulator review of the voted read by the scanner at a voting terminal. In cases where DRE-based or Internet-based voting is used, a review image may be generated and stored, which may be signed, encrypted and transferred along with the ballot choices or cast vote record.

In cases where a voter wishes to change selections after viewing the review screen, the voter may to return to the ballot and the digital file with the vote selections may be removed from memory storage, or maintained as a non-counted ballot.

The voter-verified digital audit trail file, as indicated above, may be a visual digital file, such as an image file, with human readable features to allow it to be seen and read by the voter to be confirmed. In some cases, such a file may also contain non-human readable features such as machine scannable features, scannable ballot choices, bar codes, metadata, or any combination thereof. The voter-verified digital audit trail file may also, in some cases, serve as the basis of the printed record itself (e.g., a ballot primitive), in the case of ballot marking systems. Such a voter-verified digital audit trail file may provide a single digital record that contains information to audit the ballot or perform a recount, and may be software independent and printable.

In some cases, the voter-verified digital audit trail file may be digitally signed to provide an ability to confirm that the record was not subjected to tampering and changes after the voter has confirmed the selections. In certain cases, the voter-verified digital audit trail file may be amended post-confirmation to show ballot processing changes that may occur, such as preferential voting reallocation, write in candidate assignments, removal due to voter ineligibility, any other ballot processing an election official may perform, or any combinations thereof. In some cases, voter-verified digital audit trail file may be stored as an encrypted record to prevent other computer systems from being able to process the voter-verified digital audit trail file.

Aspects of the disclosure are initially described in the context of a voting system, followed by various examples of voter-verified digital audit trails that illustrate several examples of techniques in accordance with the disclosure. Aspects of the disclosure are further illustrated by and described with reference to apparatus diagrams, system diagrams, and flowcharts that relate to voter-verified digital audit trails in voting systems.

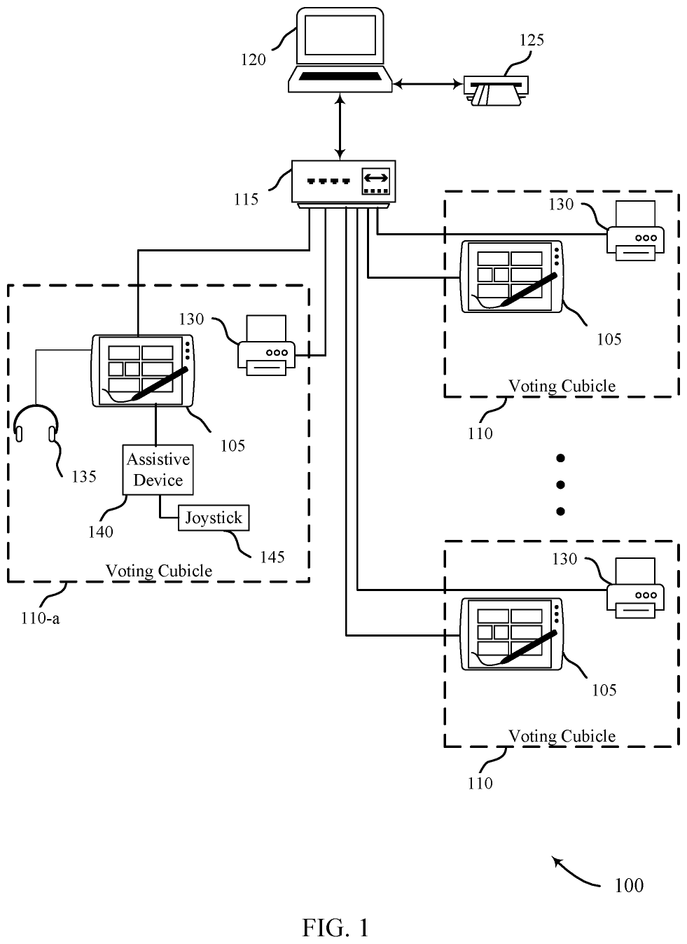

FIG. 1 illustrates an example of a voting system 100 in accordance with various aspects of the present disclosure. The voting system 100 includes a number of voter terminals 105 that may be located, in some examples, at voting cubicles 110. In some examples, the voting system 100 may be a precinct voting system that is deployed at a voting precinct or voting center in which a number of different voters may concurrently vote in separate voting cubicles 110. In some cases, the voting cubicles 110 may be voting carrels with privacy walls and a curtain that may provide privacy to a voter. In some cases, one or more voter terminals 105 may not be located in a voting cubicle 110 or voting booth, and may simply be handheld devices that may be held by a voter or placed on a table. A network hub 115 may provide a network connection to each voting terminal 105. In the example of FIG. 1 the network connection is a wired connection (e.g., an Ethernet connection), although in some cases wireless connections may be provided. In some cases, a wired connection is provided for security purposes, but which may be disconnected after a voter is authenticated for voting by the voter, and then reconnected once the voter completes voting to download a cast vote record and voter-verified digital audit trail, and optionally print a ballot or paper audit trail such as using a printer 130.

In the system 100 of FIG. 1, the voter terminals 105 may include DRE terminals, optical scan terminals, an audio voting terminal, or any other voter terminal that provides a voter with an interface through which votes may be entered and confirmed. In cases where the voter terminal 105 includes a DRE terminal, a touch screen, graphical user interface, audio interface, or other user interface may be configured to provide options for one or more votes (e.g., candidate names, referendum answers, etc.) and to receive inputs from the voter to select one of the options as the voter's vote. In cases where the voter terminal includes an optical scan system, the system may be configured to receive voter-marked paper ballots (e.g., through a ballot feed mechanism receives ballots and feeds the ballots through a scanner), scan the ballots, and perform image processing to identify markings on the ballot that indicate one or more votes made on the voter-marked paper ballot.

The system 100 of this example also includes one or more accessible voting cubicles 110-a, which may be equipped with headphones 135 for audio ballots, an assistive device 140 for receiving inputs from a voter (e.g., a sip-puff interface, a TECLA box from Komodo OpenLab Inc. of Toronto Canada, etc.), and a joystick 145 that may be used for receiving inputs from a voter.

In the system 100, an administrative computer 120 may also be coupled with the network hub 115. The administrative computer 120, in some cases, may be used by an election official to generate voting sessions for a voter and initiate a voting session at a voter terminal 105. In some cases, the administration computer 120 may be connected to the network hub 115 and may control the voter terminal 105 to start a voting session. In some cases, an election official at the administration computer 120 may generate voter credentials that are programmed into a voter card at a card programmer 125, that may be provided to the voter and used to load a ballot at a voter terminal 105 and initiate a voting session. The administration computer 120, in some cases, may include information for voters that are eligible to vote at a particular location and information for which particular districts that the voters are to vote in, and this information may be used to generate a ballot to be voted by the voter.

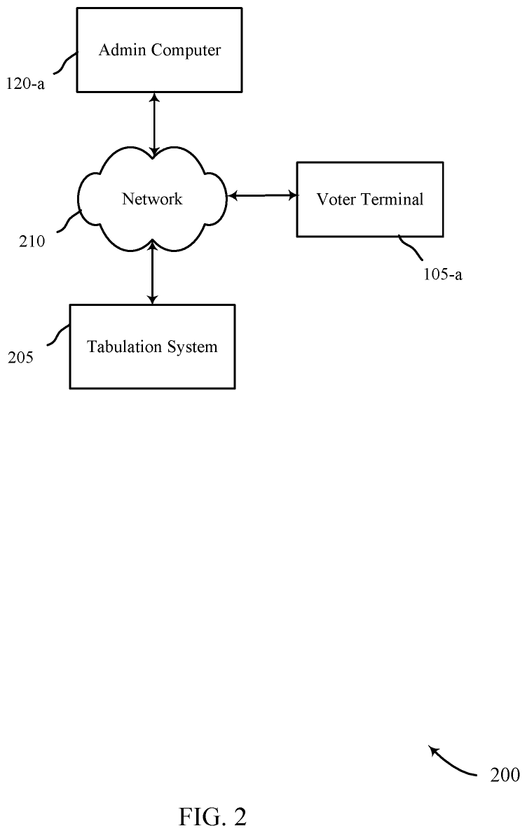

FIG. 2 illustrates a more generalized block diagram of a voting system 200 in accordance with various aspects of the present disclosure. The voting system 200 includes a voter terminal 105-a which may be an example of a voter terminal 105 of FIG. 1, a tabulation system 205, a communications network 210 which may include a network hub 115 such as in FIG. 1, and an administration computer 120-a. In the system 200 of FIG. 2, the voter terminal 105-a, similarly as discussed with respect to FIG. 1, may include a DRE terminal, an optical scan system, an audio voting terminal, or any other voter terminal that provides a voter with an interface through which votes may be entered and confirmed.

The voter terminal 105-a, after identifying votes entered by a voter, may generate a digital file containing a list of one or more votes that have been identified. The digital file may be a digital image file that may be used to display an image of the identified votes, or an audio file that may be used to play the identified votes. The digital file may be stored, and provided to the voter at the voter terminal 105-a, and the voter may verify that the listed votes accurately represent the votes cast by the voter, which may be used to generate a cast vote record at the voter terminal 105-a. The voter verification and the verified digital file may be stored as a voter-verified digital audit trail, and may in some cases be provided to the tabulation system 205 along with a cast vote record of the voter. In some cases, the digital audit trail file may include an image in any suitable image file such as, for example, a bitmap image, a jpeg image, a tiff image, a gif image, a png image, or a pdf image.

In some cases, the digital file may be a digital image identifying one or more votes made by the voter, and may contain information in a text format that can be interpreted by the voter, and optionally may include information in a machine-readable code that can be interpreted by a scanner or computer. In some cases, the voter terminal 105-a may generate a digital signature for the digital audit trail file and the voter verification, which may be appended to the digital audit trail file and the voter verification and stored in memory. In some cases, the digital signature may be a cryptographic hash of the digital image, the voter verification of the one or more votes, or any combination thereof. In some cases, all of the stored information associated with a ballot and voter-verified digital audit trail file is encrypted.

The tabulation system 205 may be coupled with the voter terminal 105-a either directly or via network 210. The tabulation system 205, in some cases, may receive a cast vote record from multiple voter terminals 105-a and tabulate results that may be used to determine the outcome of an election. The network 210, in some cases, is a local network that does not provide any connections to an external network or any devices that can be connected to an external network, thus providing a closed system that is relatively secure from any unauthorized access from outside parties. In some cases, tabulation results from the tabulation system 205 may be transferred (e.g., via a removable and portable memory device) to a central counting location (e.g., a county clerk or secretary of state office) for use in total vote counts and election certification. In some cases, the voter terminal 105-a may provide the digital audit trail file and voter confirmation to the tabulation system 205, which may be provided as a single file or as separate files that may be linked to the cast vote record.

In some cases, post-voting ballot processing may be performed on a ballot that is cast by a voter. Such post-voting ballot processing may include, for example, a preferential voting reallocation process, an assignment of one or more write-in candidates, a removal of one or more votes based on voter ineligibility, or any combination thereof. In such cases, the tabulation system 205 may update the digital image and voter verification of the one or more votes based at least in part on the ballot processing, and store the updated digital image and voter verification in memory to provide the voter-verified digital audit trail. In some cases, a log of the ballot processing may be appended to the voter-verified digital audit trail. In some cases, following an initial count of votes for an election, a recount may be performed, and the voter-verified digital audit trail may be used when re-tallying votes for one or more races or ballot issues. The administration computer 120-a, similarly as discussed above, may be used by an election official to generate voting sessions for a voter and initiate a voting session at the voter terminal 105-a.

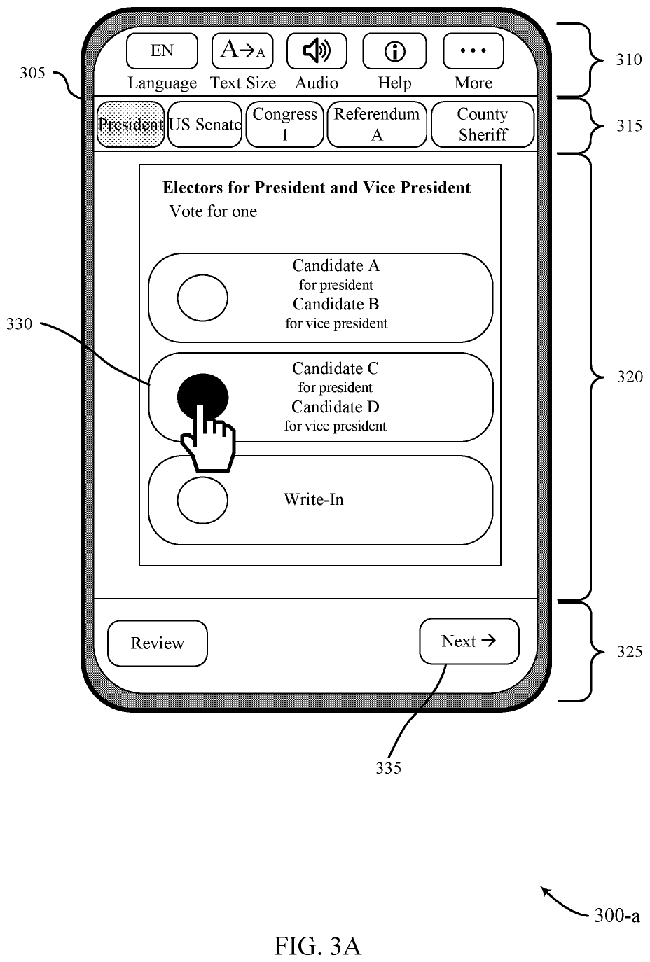

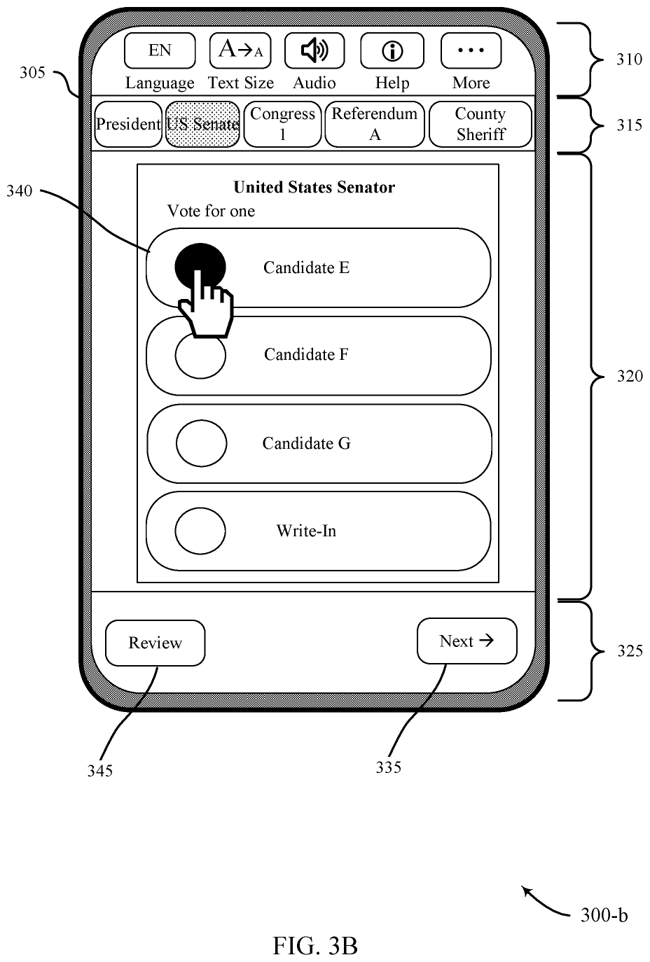

With reference now to FIGS. 3A and 3B, an example of an electronically voted ballot at an electronic voter interface 300 is described in accordance with various aspects of the present disclosure. In some examples, voter interface 300 may be an example of voter terminal 105 of FIG. 1 or 2. The voter interface 300 may be, for an example, a DRE voter interface, or a voter interface that may be used to enter ballot selections before printing a paper ballot containing the votes of the voter. The voter interface 300-a of FIG. 3A, for example, includes a display housing 305 and a display having a control portion 310 that may be used to control aspects of a display or audio output of the voter interface 300. A race indication portion 315 of the display may indicate which of several races (e.g., president, US senate, congressional representative, referendum, and county sheriff, as illustrated in this example), and a selection portion 320 may list the individual candidates or answers that are available for selection for a particular race. In the example of FIG. 3A, the selection portion 320 indicates candidates for electors for president and vice president, and the voter in this example has selected Candidate C for president and Candidate D for vice president as indicated at 330. A navigation portion 325 may provide controls for advancing through races, such as a next race selection 335, or for reviewing currently entered vote selections.

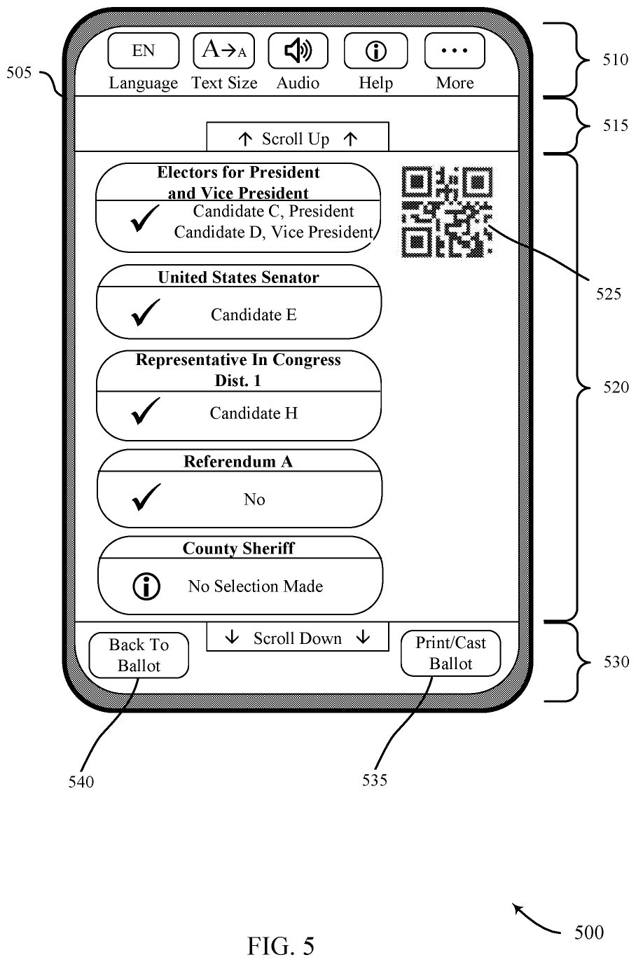

In such a system, a voter may navigate through one or more votes that are to be made in an election at the voter interface. In the example of FIG. 3B, the selection portion 320 of the display on voter interface 300-b indicates choices for United States senator, and the voter in this example has selected Candidate E, as indicated at 340. A voter using such a voter interface 300 may navigate through each of the races in the race indication portion 315 to populate voter selections for an entire ballot. Once the voter has completed entering selections, the voter may select the review 345 option on the display to generate a display of the selections made by the voter, as will be discussed in more detail below with respect to FIG. 5.

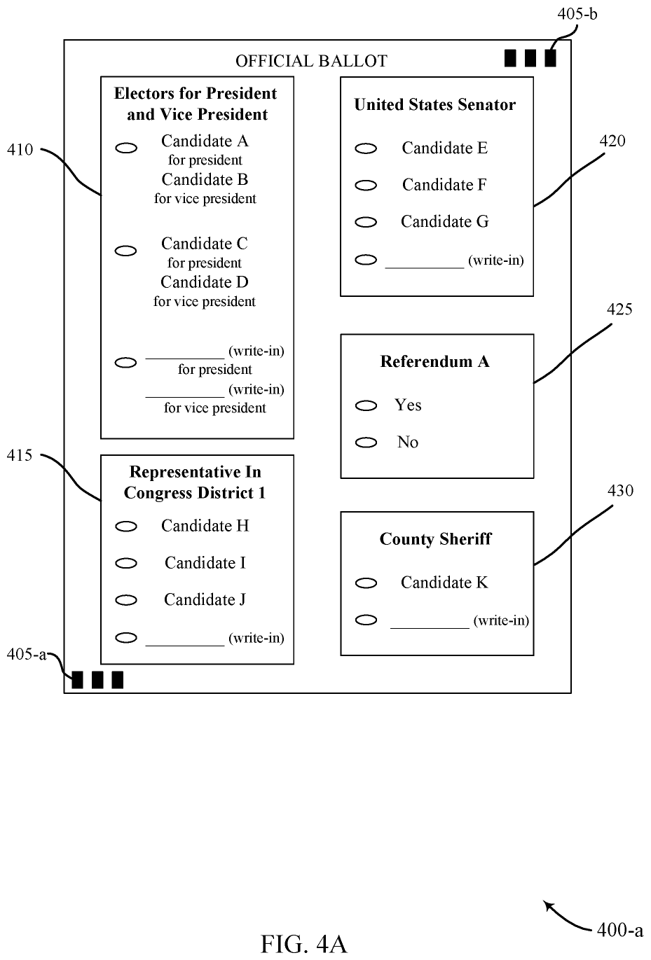

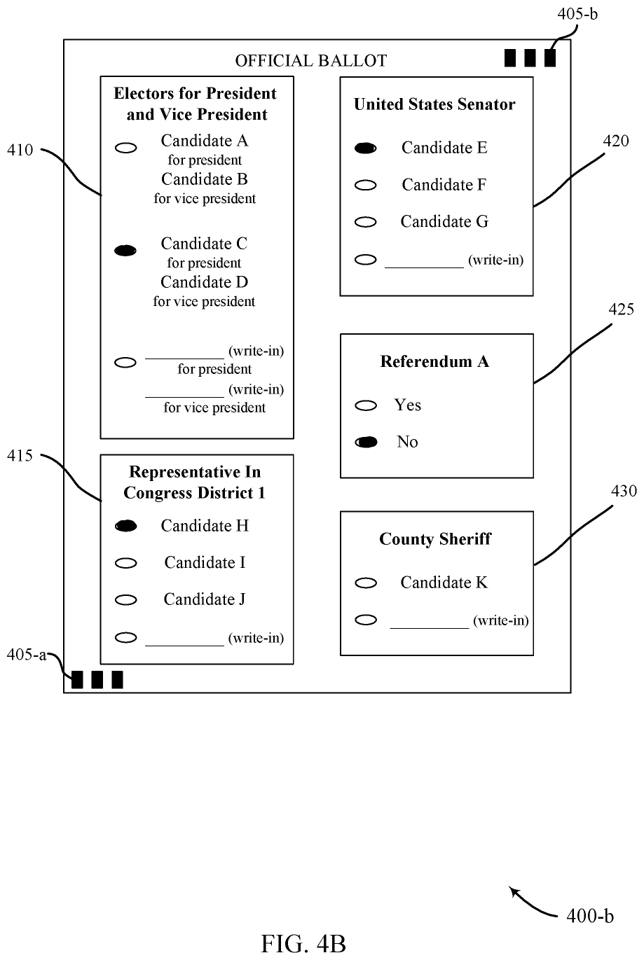

With reference now to FIGS. 4A and 4B, an example of a paper ballot 400 is described in accordance with various aspects of the present disclosure. In some examples, paper ballot 400 may be used in aspects of voting system 100 or 200. An initial blank paper ballot 400-a is illustrated in FIG. 4A, and a marked paper ballot 400-b is illustrated in FIG. 4B. The ballot 400 includes a number of voter selection areas 410, 415, 420, 425, and 430 that represent voter selections for different offices or ballot questions. Paper ballots such as ballot 400 may include pre-printed ballots and/or ballots printed locally on-demand by a local printer, and may include registration marks 405-a and 405-b that may assist an optical scan system to perform image processing to identify voter markings on the ballot 400 and identify selections of the voter based on identified voter markings. The voter will generally take the blank paper ballot 400-a to a private area (e.g., a desk with privacy barriers), and make a mark or marks (this can be done in numerous ways such as filling in a box or oval, etc.) beside the chosen candidate(s) with a marking instrument. While this disclosure may generally refer to selection of a candidate or candidates, it will be readily understood that some votes relate to other questions such as referendum questions, ballot initiatives, and the like. The concepts described herein extend to votes obtained all matters whether candidates, weighted candidate votes, referendum questions and the like.

After the voter has marked the ballot 400-b, the voter may provide the ballot to be tabulated. In some situations, election officials may direct the voter to place the ballot into an optical scan ballot system, such as an optical scan voter terminal 105 of FIG. 1 or 2, that scans the ballot and performs processing to determine the votes on the ballot. In some cases, once the voter has provided the marked ballot 400-b to an optical scan system, the system may generate a display of the selections made by the voter, as will be discussed in more detail below with respect to FIG. 5.

FIG. 5 illustrates an example of a verification screen for a voted ballot at an electronic voter interface 500 in accordance with various aspects of the present disclosure. In some examples, voter interface 500 may be an example of voter terminal 105 of FIG. 1 or 2, or an example of voter interface 300 of FIGS. 3A and 3B. The voter interface 500 of this example includes a display housing 505 and a display having a control portion 510 that may be used to control aspects of a display or audio output of the voter interface 500. Navigation portions 515 and 530 may be used to scroll up and down a list of selections made by the voter and to print/cast the ballot or go back to the ballot to change one or more votes. A digital image area 520 may be used to display a digital image file that contains a list of selections made by the voter. As discussed above, the digital image file includes information that may be read by the voter, and may also include machine-readable information 525 that may be read by a computer or scanner that also includes voter selection information. In cases where a voter is satisfied with the selections made on the ballot, the voter may select print/cast ballot 535, which may generate a voter verification of the displayed image file and also initiate the voter interface 500 to generate a cast vote record. If the voter is not satisfied with the selections, the voter may select back to ballot 540 to return to the ballot and modify one or more selections, or in cases where the voter marked a paper ballot, to return the ballot or generate a new ballot to be re-marked.

As discussed above, the voter interface 500, prior to displaying the list of selections in the digital image area 520, may identify the selections made by the voter and generate a digital image file that is stored in a memory of the device. The digital image file may be verified when the voter selects print/cast ballot 535, and the voter verification of the selections may be linked to the digital image file to create a voter-verified digital audit trail. As discussed above, the voter interface 500 may, in some cases, also generate a cast vote record and provide the cast vote record and voter-verified digital audit trail to a tabulation system for tabulation with other cast ballots by other voters. In cases where a voter uses an audio interface, a suitable audio interface may be provided (e.g., headphones, joystick, sip-puff interface, etc.) and the digital audit trail file may be an audio file rather than an image file.

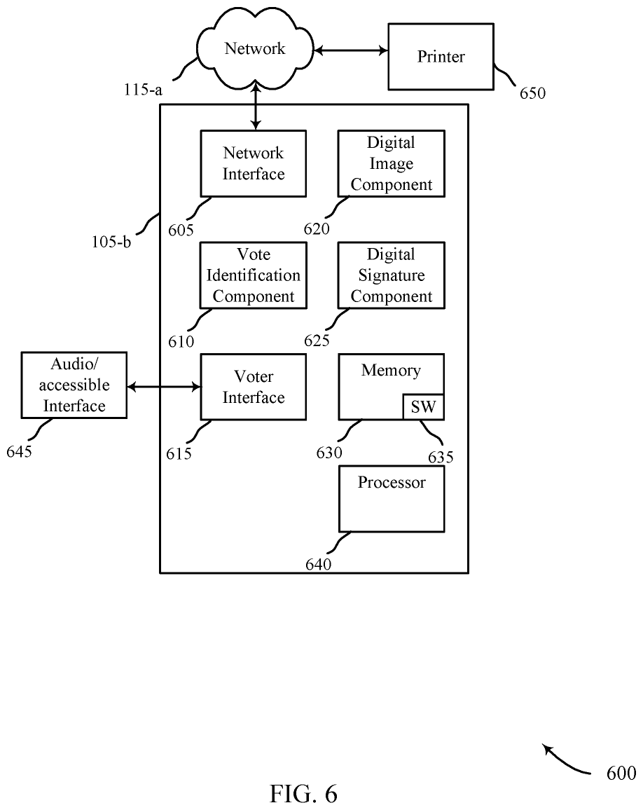

FIG. 6 shows a block diagram 600 of a voter terminal 105-b that provides a voter-verified digital audit trail in accordance with aspects of the present disclosure. Voter terminal 105-b may be an example of aspects of voter terminal 105 as described in FIG. 1 or 2, voter interface 300 as described in FIGS. 3A and 3B, or voter interface 500 as described in FIG. 5. Voter terminal 105-b may be coupled with a network hub 115-a (or other network) via network interface 605, and may include a vote identification component 610, a voter interface 615 (which may be coupled with an audio/accessible interface 645), a digital image component 620, a digital signature component 625, and a memory 630 that may include software 635 used to execute instructions to provide voter verified digital audit trails as discussed herein. Voter terminal 105-b may also include a processor 640. Each of these components may be in communication with one another (e.g., via one or more buses). In some examples, voter terminal 105-b may also be connected to a printer 650, either directly or through network hub 115-a.

Voter terminal 105-b and/or at least some of its various sub-components may be implemented in hardware, software executed by a processor, firmware, or any combination thereof. If implemented in software executed by a processor, the functions of the voter terminal 105-b and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The voter terminal 105-b and/or at least some of its various sub-components may be physically located at various positions, including being distributed such that portions of functions are implemented at different physical locations by one or more physical devices. In some examples, voter terminal 105-b and/or at least some of its various sub-components may be a separate and distinct component in accordance with various aspects of the present disclosure. In other examples, voter terminal 105-b and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

In some cases, the vote identification component 610 may identify one or more selections made by a voter on a ballot. Such vote identification may be based on voter inputs to a DRE interface that is part of voter interface 615, may be based on an optical scan and image processing or a voter-marked paper ballot, may be based on inputs from audio/accessible interface 645, or combinations thereof. The voter identification component may provide the identified selections of the voter to digital image component 620, which may generate a digital image of the identified voting selections. In cases where an audio format ballot or other format ballot is used by the voter, the digital image component 620 may generate a digital file in accordance with the format of the ballot format, such as an audio file or video file. As discussed, above, the digital image or other digital file may be presented to the voter at voter interface 615 for verification. In some cases, digital signature component may receive the voter verification and provide a digital signature for the digital image file and verification. In some cases, digital signature component 625 may provide a cryptographic hash for the digital image file and voter verification. In some cases, the digital image file and verification may be stored in memory 630, and may be encrypted.

The processor 640 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). Processor 640 may be configured to execute computer-readable instructions stored in a memory to perform various functions (e.g., functions or tasks supporting voter-verified voting audit trails).

Memory 630 may include random access memory (RAM) and read only memory (ROM). The memory 630 may store computer-readable, computer-executable software 635 including instructions that, when executed, cause the processor to perform various functions described herein. In some cases, the memory 630 may contain, among other things, a basic input/output system (BIOS) which may control basic hardware or software operation such as the interaction with peripheral components or devices. Memory 630 may be a single memory component or distributed across two or more components that include memory.

Software 635 may include code to implement aspects of the present disclosure, including code to support voter verified digital audit trails. Software 635 may be stored in a non-transitory computer-readable medium such as system memory or other memory. In some cases, the software 635 may not be directly executable by the processor but may cause a computer (e.g., when compiled and executed) to perform functions described herein.

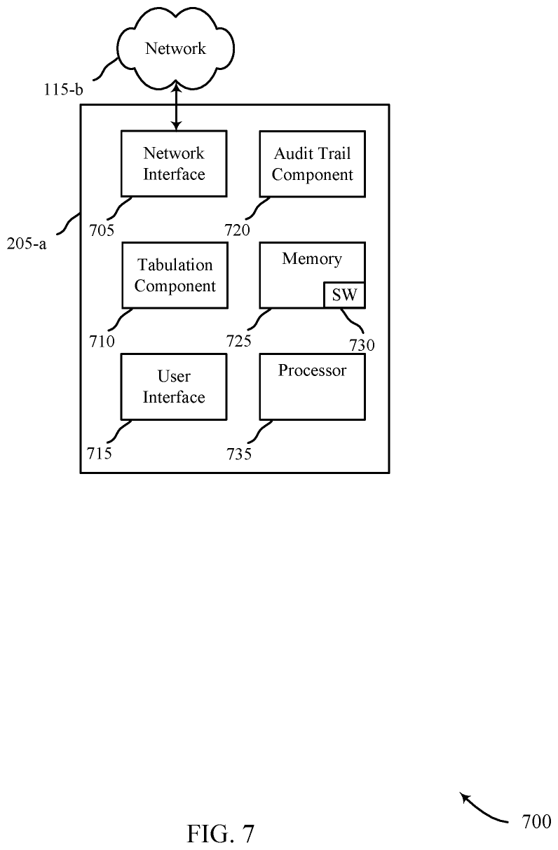

FIG. 7 shows a block diagram 700 of a tabulation system 205-a that provides a voter-verified digital audit trail in accordance with aspects of the present disclosure. Tabulation system 205-a may be an example of aspects of tabulation system 205 as described in FIG. 2 and as described with respect to FIGS. 2-5. Tabulation system 205-a may be coupled with a network hub 115-b (or other network) via network interface 705, and may include a tabulation component 710, a user interface 715, an audit trail component 720, and a memory 725 that may include software 730 used to execute instructions to provide voter verified digital audit trails as discussed herein. Tabulation system 205-a may also include a processor 735. Each of these components may be in communication with one another (e.g., via one or more buses).

Tabulation system 205-a and/or at least some of its various sub-components may be implemented in hardware, software executed by a processor, firmware, or any combination thereof. If implemented in software executed by a processor, the functions of the tabulation system 205-a and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The tabulation system 205-a and/or at least some of its various sub-components may be physically located at various positions, including being distributed such that portions of functions are implemented at different physical locations by one or more physical devices. In some examples, tabulation system 205-a and/or at least some of its various sub-components may be a separate and distinct component in accordance with various aspects of the present disclosure. In other examples, tabulation system 205-a and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

In some cases, the tabulation component 710 may receive a cast vote record from a voter terminal and use the cast vote record to tabulate one or more votes case by a voter in an election with votes of other voters in the election. In some cases, audit trail component 720 may receive a voter-verified digital audit trail file and may store the file in memory 725 with a link to the cast vote record. In some cases, processor 735 may perform post-voting ballot processing on a ballot which may include, for example, a preferential voting reallocation process, an assignment of one or more write-in candidates, a removal of one or more votes based on voter ineligibility, or any combination thereof. In such cases, the tabulation component 710 may update the digital image and voter verification of the one or more votes based at least in part on the ballot processing, and store the updated digital image and voter verification in memory 725 to provide the voter-verified digital audit trail. In some cases, a log of the ballot processing may be appended to the voter-verified digital audit trail. In some cases, following an initial count of votes for an election, a recount may be performed, and the voter-verified digital audit trail may be used when re-tallying votes for one or more races or ballot issues.

Processor 735 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 735 may be configured to operate a memory array using a memory controller. In other cases, a memory controller may be integrated into processor 735. Processor 735 may be configured to execute computer-readable instructions stored in a memory to perform various functions (e.g., functions or tasks supporting voter-verified digital audit trails).

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a basic input/output system (BIOS) which may control basic hardware or software operation such as the interaction with peripheral components or devices.

Software 730 may include code to implement aspects of the present disclosure, including code to support voter-verified digital audit trails. Software 730 may be stored in a non-transitory computer-readable medium such as system memory or other memory. In some cases, the software 730 may not be directly executable by the processor but may cause a computer (e.g., when compiled and executed) to perform functions described herein. In some cases, tabulation system 205-a may utilize an operating system such as iOS®, ANDROID®, MS-DOS®, MS-WINDOWS®, OS/2®, UNIX®, LINUX®, or another known operating system. In other cases, tabulation system 205-a may represent or interact with a modem, a keyboard, a mouse, a touchscreen, or a similar device via user interface 715.

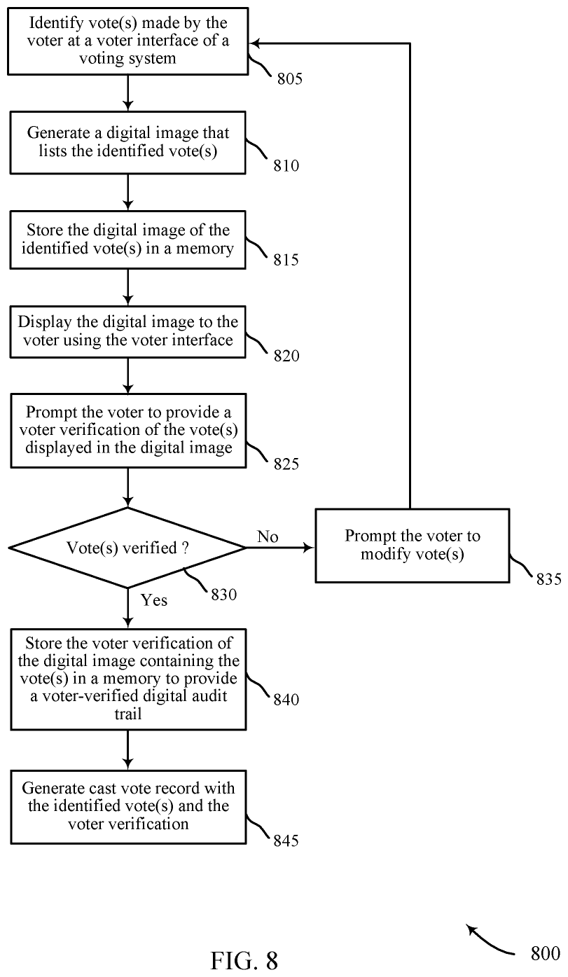

FIG. 8 shows a flowchart illustrating a method 800 for generating a voter-verified voting audit trail in accordance with aspects of the present disclosure. The operations of method 800 may be implemented by a voter terminal or its components as described herein. For example, the operations of method 800 may be performed by a voter terminal 105 described in FIG. 1 or 2, a voter interface 300 as described in FIGS. 3A and 3B, voter interface 500 as described in FIG. 5, or a voter terminal 105-b described in FIG. 6. In some examples, a voter terminal may execute a set of codes to control the functional elements of the device to perform the functions described below. Additionally or alternatively, the voter terminal may perform aspects of the functions described below using special-purpose hardware.

At 805 the voter terminal may identify vote(s) made by the voter at a voter interface of a voting system. The operations of 805 may be performed according to the methods described herein. In certain examples, aspects of the operations of 805 may be performed by a vote identification component as described with reference to FIG. 6. In some cases, the votes may be identified through a DRE interface at the voter terminal, an optical scan interface at the terminal that may perform image processing to identify voter markings as identified votes, or an audio/accessible interface at the voter terminal.

At 810 the voter terminal may generate a digital image that lists the identified vote(s). The operations of 810 may be performed according to the methods described herein. In certain examples, aspects of the operations of 810 may be performed by a digital image component as described with reference to FIG. 6. In some cases, the digital image may be any type of digital image such as, for example, a bitmap image, a jpeg image, a tiff image, a gif image, a png image, or a pdf image.

At 815 the voter terminal may store the digital image of the identified vote(s) in a memory. The operations of 815 may be performed according to the methods described herein. In certain examples, aspects of the operations of 815 may be performed by a digital image component and memory as described with reference to FIG. 6.

At 820 the voter terminal may display the digital image to the voter using the voter interface. The operations of 820 may be performed according to the methods described herein. In certain examples, aspects of the operations of 820 may be performed by a voter interface as described with reference to FIG. 6.

At 825 the voter terminal may prompt the voter to provide a voter verification of the vote(s) displayed in the digital image. The operations of 825 may be performed according to the methods described herein. In certain examples, aspects of the operations of 825 may be performed by a voter interface as described with reference to FIG. 6.

At 830 the voter terminal may determine if the vote(s) are verified by the voter. The operations of 830 may be performed according to the methods described herein. In certain examples, aspects of the operations of 830 may be performed by a voter interface as described with reference to FIG. 6.

If the vote(s) are not verified at 830, the voter terminal at 835 may prompt the voter to modify vote(s). The operations of 835 may be performed according to the methods described herein. In certain examples, aspects of the operations of 835 may be performed by a voter interface as described with reference to FIG. 6.

If the vote(s) are verified at 830, the voter terminal at 840 may store the voter verification of the digital image containing the vote(s) in a memory to provide a voter-verified digital audit trail. The operations of 840 may be performed according to the methods described herein. In certain examples, aspects of the operations of 840 may be performed by a digital image component and memory as described with reference to FIG. 6.

At 845 the voter terminal may generate a cast vote record with the identified vote(s) and the voter verification. The case vote record becomes the basis for an official tally of election results. The operations of 845 may be performed according to the methods described herein. In certain examples, aspects of the operations of 845 may be performed by a processor as described with reference to FIG. 6.

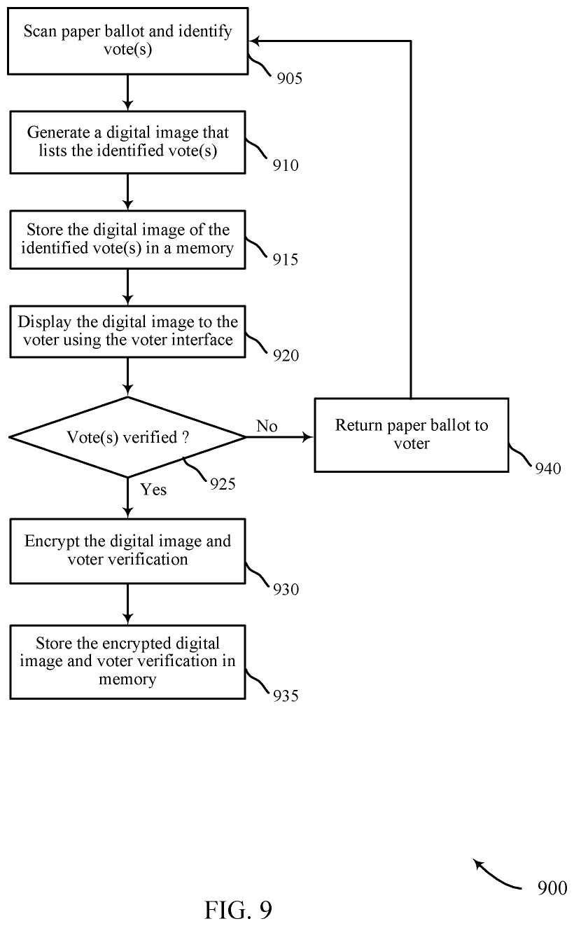

FIG. 9 shows a flowchart illustrating a method 900 for generating a voter-verified voting audit trail in accordance with aspects of the present disclosure. The operations of method 900 may be implemented by a voter terminal or its components as described herein. For example, the operations of method 900 may be performed by a voter terminal 105 described in FIG. 1 or 2, voter interface 500 as described in FIG. 5, or a voter terminal 105-b described in FIG. 6. In some examples, a voter terminal may execute a set of codes to control the functional elements of the device to perform the functions described below. Additionally or alternatively, the voter terminal may perform aspects of the functions described below using special-purpose hardware.

At 905 the voter terminal may scan a paper ballot and identify vote(s) recorded on the paper ballot. The operations of 905 may be performed according to the methods described herein. In certain examples, aspects of the operations of 905 may be performed by a vote identification component as described with reference to FIG. 6. In some cases, the votes may be identified through an optical scan interface at the terminal that may perform image processing to identify voter markings as identified votes.

At 910 the voter terminal may generate a digital image that lists the identified vote(s). The operations of 910 may be performed according to the methods described herein. In certain examples, aspects of the operations of 910 may be performed by a digital image component as described with reference to FIG. 6. In some cases, the digital image may be any type of digital image such as, for example, a bitmap image, a jpeg image, a tiff image, a gif image, a png image, or a pdf image.

At 915 the voter terminal may store the digital image of the identified vote(s) in a memory. The operations of 915 may be performed according to the methods described herein. In certain examples, aspects of the operations of 915 may be performed by a digital image component and memory as described with reference to FIG. 6.

At 920 the voter terminal may display the digital image to the voter using the voter interface. The operations of 920 may be performed according to the methods described herein. In certain examples, aspects of the operations of 920 may be performed by a voter interface as described with reference to FIG. 6.

At 925 the voter terminal may determine if the vote(s) are verified by the voter. The operations of 925 may be performed according to the methods described herein. In certain examples, aspects of the operations of 925 may be performed by a voter interface as described with reference to FIG. 6.

If the vote(s) are not verified at 925, the voter terminal at 940 may return the paper ballot the voter. In some cases, the voter may modify the paper ballot and repeat operations starting at 905. In some cases, the paper ballot may be returned to the voter to be destroyed and the voter may complete a new ballot. The operations of 925 may be performed according to the methods described herein. In certain examples, aspects of the operations of 925 may be performed by a voter interface as described with reference to FIG. 6

At 930, if the vote(s) are verified at 925, the voter terminal may encrypt the digital image and voter verification. The operations of 930 may be performed according to the methods described herein. In certain examples, aspects of the operations of 930 may be performed by a digital signature component as described with reference to FIG. 6.

At 935 the voter terminal may store the encrypted digital image and voter verification in a memory to provide a voter-verified digital audit trail. The operations of 935 may be performed according to the methods described herein. In certain examples, aspects of the operations of 935 may be performed by a digital signature component and memory as described with reference to FIG. 6.

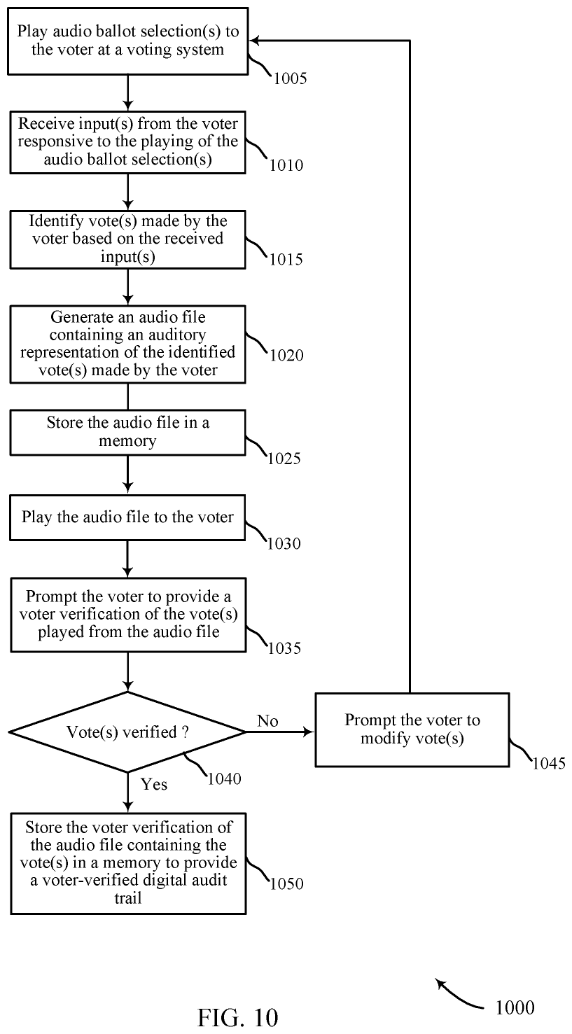

FIG. 10 shows a flowchart illustrating a method 1000 for generating a voter-verified voting audit trail in accordance with aspects of the present disclosure. The operations of method 1000 may be implemented by a voter terminal or its components as described herein. For example, the operations of method 1000 may be performed by a voter terminal 105 described in FIG. 1 or 2, a voter interface 300 as described in FIGS. 3A and 3B, voter interface 500 as described in FIG. 5, or a voter terminal 105-b described in FIG. 6. In some examples, a voter terminal may execute a set of codes to control the functional elements of the device to perform the functions described below. Additionally or alternatively, the voter terminal may perform aspects of the functions described below using special-purpose hardware.

At 1005 the voter terminal may play audio ballot selection(s) to the voter at a voting system. The operations of 1005 may be performed according to the methods described herein. In certain examples, aspects of the operations of 1005 may be performed by a vote identification component as described with reference to FIG. 6. In some cases, the audio ballot selections may be played through an audio/accessible interface at the voter terminal.

At 1010 the voter terminal may receive input(s) from the voter responsive to the playing of the audio ballot selection(s). The operations of 1005 may be performed according to the methods described herein. In certain examples, aspects of the operations of 1005 may be performed by a vote identification component as described with reference to FIG. 6. In some cases, the inputs from the voter may be received through the audio/accessible interface at the voter terminal.

At 1015 the voter terminal may identify vote(s) made by the voter based in the received input(s). The operations of 1015 may be performed according to the methods described herein. In certain examples, aspects of the operations of 1005 may be performed by a vote identification component as described with reference to FIG. 6.

At 1020 the voter terminal may generate an audio file containing an auditory representation of the identified vote(s) made by the voter. The operations of 1020 may be performed according to the methods described herein. In certain examples, aspects of the operations of 1020 may be performed by a digital image component as described with reference to FIG. 6. In some cases, the audio file may be any type of digital audio file such as, for example, a mpeg file, a way file, or a wma file.

At 1025 the voter terminal may store the audio file with the identified vote(s) in a memory. The operations of 1025 may be performed according to the methods described herein. In certain examples, aspects of the operations of 1025 may be performed by a digital image component and memory as described with reference to FIG. 6.

At 1030 the voter terminal may play the audio file to the voter. The operations of 1030 may be performed according to the methods described herein. In certain examples, aspects of the operations of 1030 may be performed by a voter interface as described with reference to FIG. 6. In some cases, the audio file may be played through the audio/accessible interface at the voter terminal.

At 1035 the voter terminal may prompt the voter to provide a voter verification of the vote(s) played for the voter. The operations of 1035 may be performed according to the methods described herein. In certain examples, aspects of the operations of 1035 may be performed by a voter interface as described with reference to FIG. 6.

At 1040 the voter terminal may determine if the vote(s) are verified by the voter. The operations of 1040 may be performed according to the methods described herein. In certain examples, aspects of the operations of 1040 may be performed by a voter interface as described with reference to FIG. 6.

If the vote(s) are not verified at 1040, the voter terminal at 1045 may prompt the voter to modify vote(s). The operations of 1045 may be performed according to the methods described herein. In certain examples, aspects of the operations of 1045 may be performed by a voter interface as described with reference to FIG. 6.

If the vote(s) are verified at 1040, the voter terminal at 1050 may store the voter verification of the audio file containing the vote(s) in a memory to provide a voter-verified digital audit trail. The operations of 1050 may be performed according to the methods described herein. In certain examples, aspects of the operations of 1050 may be performed by a digital image component and memory as described with reference to FIG. 6.

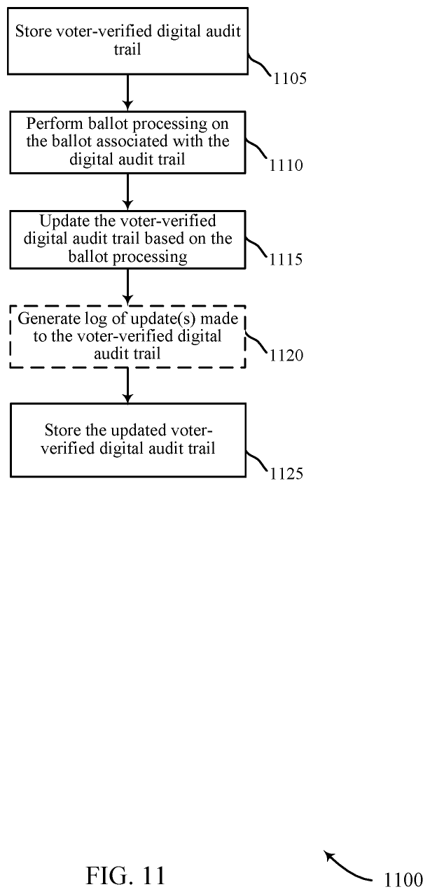

FIG. 11 shows a flowchart illustrating a method 1100 for generating a voter-verified voting audit trail after ballot processing in accordance with aspects of the present disclosure. The operations of method 1100 may be implemented by a tabulation system or its components as described herein. For example, the operations of method 1100 may be performed by a tabulation system 205 described in FIG. 2, or a tabulation system 205-a described in FIG. 7. In some examples, a tabulation system may execute a set of codes to control the functional elements of the device to perform the functions described below. Additionally or alternatively, the tabulation system may perform aspects of the functions described below using special-purpose hardware.

At 1105 the tabulation system may store a voter-verified digital audit trail. The operations of 1105 may be performed according to the methods described herein. In certain examples, aspects of the operations of 1105 may be performed by an audit trail component as described with reference to FIG. 7.

At 1110 the tabulation system may perform ballot processing on the ballot associated with the digital audit trail. The operations of 1110 may be performed according to the methods described herein. In certain examples, aspects of the operations of 1110 may be performed by a tabulation component as described with reference to FIG. 7. In some cases, the ballot processing may include preferential voting reallocation, write in candidate assignments, removal due to voter ineligibility, any other ballot processing an election official may perform, or any combinations thereof.

At 1115 the tabulation system may update the voter-verified digital audit trail based on the ballot processing. The operations of 1115 may be performed according to the methods described herein. In certain examples, aspects of the operations of 1115 may be performed by the audit trail component as described with reference to FIG. 7.

Optionally, at 1120 the tabulation system may generate log of update(s) made to the voter-verified digital audit trail. The operations of 1120 may be performed according to the methods described herein. In certain examples, aspects of the operations of 1120 may be performed by the audit trail component as described with reference to FIG. 7.

At 1125 the tabulation system may store the updated voter-verified digital audit trail. The operations of 1125 may be performed according to the methods described herein. In certain examples, aspects of the operations of 1125 may be performed by the audit trail component and memory as described with reference to FIG. 7.

It should be noted that the methods described above describe possible implementations, and that the operations and the steps may be rearranged or otherwise modified and that other implementations are possible. Further, aspects from two or more of the methods may be combined.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for verifying a vote cast by a voter, comprising:
identifying one or more votes made by the voter at a voter interface of a voting system;
generating a digital image that lists the identified one or more votes made by the voter;
storing the digital image of the one or more votes in a memory;
displaying the digital image to the voter using the voter interface;
prompting, via the voter interface, the voter to provide a voter verification of the one or more votes displayed in the digital image;
receiving the voter verification at the voter interface; and
storing the voter verification of the digital image containing one or more votes in the memory to provide a voter-verified digital audit trail of the one or more votes made by the voter.

2. The method of claim 1, further comprising:
generating a cast vote record at the voting system based at least in part on the verified one or more votes made by the voter; and
providing the cast vote record to a tabulation system.

3. The method of claim 2, further comprising:
linking the stored digital image and the voter verification to the cast vote record.

4. The method of claim 2, wherein:
the generating of the cast vote record is initiated only after the voter verification of the digital image.

5. The method of claim 1, wherein:
the digital image identifying the one or more votes made by the voter contains information in a text format that can be interpreted by a voter, and contains information in a machine-readable code that can be interpreted by a scanner or computer.

6. The method of claim 1, wherein the storing comprises:
generating a digital signature for the digital image and the voter verification;
appending the digital signature to the digital image and the voter verification; and
storing the digital image, voter verification, and the digital signature in the memory.

7. The method of claim 6, wherein the digital signature comprises a cryptographic hash of the digital image, the voter verification of the one or more votes, or any combination thereof.

8. The method of claim 6, wherein the digital image and the voter verification are encrypted and stored.

9. The method of claim 1, further comprising:
performing ballot processing on the one or more received votes;
updating the digital image and the voter verification of the one or more votes based at least in part on the ballot processing; and
storing the updated digital image and voter verification of the one or more votes in the memory to provide the voter-verified digital audit trail.

10. The method of claim 9, wherein the ballot processing comprises a preferential voting reallocation process, an assignment of one or more write-in candidates, a removal of one or more votes based on voter ineligibility, or any combination thereof.

11. The method of claim 1, further comprising:
printing the digital image and the voter verification; and
providing the printed digital image and voter verification as a voter verified paper audit trail.

12. The method of claim 11, further comprising:
re-tallying votes for one or more races or ballot issues using the printed digital image and the voter verification as part of a re-count.

13. The method of claim 1, wherein the identifying the one or more votes comprises:
optically scanning a voter-marked paper ballot; and
determining the one or more votes based at least in part on markings on the voter-marked paper ballot.

14. The method of claim 1, wherein the identifying the one or more votes comprises:
receiving one or more selections from the voter on a direct record electronic (DRE) voter interface of the one or more votes.

15. The method of claim 1, wherein the digital image comprises a bitmap image, a jpeg image, a tiff image, a gif image, a png image, or a pdf image.

16. A method for verifying a vote cast by a voter, comprising:
playing one or more audio ballot selections to the voter at a voting system;
receiving one or more inputs from the voter responsive to the playing of the one or more audio ballot selections;
identifying one or more votes made by the voter at the voting system based at least in part on the received one or more inputs;
generating an audio file containing an auditory representation of the identified one or more votes made by the voter and playing the audio file to the voter;
storing the audio file of the ones or more votes in a memory;
prompting the voter to provide a voter verification of the one or more votes contained in the audio file;
receiving the voter verification; and
storing the voter verification of the one or more votes in the memory to provide a voter-verified digital audit trail of the one or more votes made by the voter.

17. The method of claim 16, further comprising:
generating a cast vote record at the voting system based at least in part on the identified one or more votes made by the voter and the voter verification;
linking the stored audio file and the voter verification to the cast vote record; and
providing the cast vote record to a tabulation system.

18. The method of claim 16, wherein the storing comprises:
generating a digital signature for the audio file and the voter verification;
appending the digital signature to the audio file and the voter verification; and
storing the audio file, voter verification, and the digital signature in the memory.

19. The method of claim 18, wherein the digital signature comprises a cryptographic hash of the audio file, the voter verification of the one or more votes, or any combination thereof.

20. The method of claim 18, wherein the audio file and the voter verification are encrypted and stored.

21. The method of claim 16, wherein the audio file comprises a way file, a mpeg file, a wma file, or other digital audio file.

22. A voting system, comprising:
an optical scanner configured to receive a voter-marked paper ballot, optically scan the voter-marked paper ballot, and output an optical image of the voter-marked paper ballot;
a vote identification component coupled with the optical scanner that is configured to receive the optical image of the voter-marked paper ballot and identify one or more votes made by the voter on voter-marked paper ballot based at least in part on an image analysis of voter markings on the voter-marked paper ballot;
a digital image generator coupled with the vote identification component that generates a digital image containing a list of the identified one or more votes made by the voter;
a voter interface coupled with the digital image generator that displays the digital image to the voter, prompts the voter to provide a voter verification of the one or more votes contained in the digital image, and receives the voter verification from the voter; and
a memory coupled with the digital image generator and the voter interface that stores the digital image and voter verification of the one or more votes to provide a voter-verified digital audit trail of the one or more votes made by the voter.

23. The voting system of claim 22, wherein:
the vote identification component is further configured to generate a cast vote record based at least in part on the identified one or more votes made by the voter and the voter verification, and link the stored digital image and the voter verification to the cast vote record.

24. The voting system of claim 22, further comprising:
a digital signature generator that generates a digital signature for the digital image and the voter verification and appends the digital signature to the digital image and the voter verification; and
wherein the memory stores the digital image, voter verification, and the digital signature.

25. The voting system of claim 24, wherein the digital signature comprises a cryptographic hash of the digital image, the voter verification of the one or more votes, or any combination thereof.

26. The voting system of claim 22, further comprising:
a printer that prints the digital image and voter verification to provide a voter verified paper audit trail.

27. The voting system of claim 22, wherein the digital image comprises a bitmap image, a jpeg image, a tiff image, a gif image, a png image, or a pdf image.

28. A voting system, comprising:
a direct record electronic (DRE) voter interface configured to provide an electronic ballot to a voter and receive one or more vote selections from the voter responsive thereto;
a vote identification component configured to identify one or more votes made by the voter based at least in part on the electronic ballot and the received one or more vote selections;
a digital image generator coupled with the vote identification component and the DRE voter interface configured to generate a digital image containing a list of the identified one or more votes made by the voter, and wherein the DRE voter interface is configured to display the digital image to the voter, prompt the voter to provide a voter verification of the one or more votes contained in the digital image, and receive the voter verification from the voter; and
a memory coupled with the digital image generator and the DRE voter interface that stores the digital image and voter verification of the one or more votes to provide a voter-verified digital audit trail of the one or more votes made by the voter.

29. The voting system of claim 28, wherein:
the vote identification component is further configured to generate a cast vote record based at least in part on the identified one or more votes made by the voter and the voter verification, and link the stored digital image and the voter verification to the cast vote record.

30. The voting system of claim 28, further comprising:
a digital signature generator that generates a digital signature for the digital image and the voter verification and appends the digital signature to the digital image and the voter verification; and
wherein the memory stores the digital image, voter verification, and the digital signature.

31. The voting system of claim 30, wherein the digital signature comprises a cryptographic hash of the digital image and the voter verification of the one or more votes.

32. The voting system of claim 28, wherein the digital image and the voter verification are encrypted and stored.

33. The voting system of claim 28, further comprising:
a printer that prints the digital image and voter verification to provide a voter verified paper audit trail.

34. The voting system of claim 28, wherein the digital image comprises a bitmap image, a jpeg image, a tiff image, a gif image, a png image, or a pdf image.
